(19) United States
(12) Patent Application Publication
(10) Pub. No.: US 2004/0240541 A1
(43) Pub. Date: Dec. 2, 2004

(54) Method and system for direct ingest and storage of digital video content with immediate access to content for browsing and editing

(75) Inventors: Henry Dexter Chadwick, Herndon, VA (US); Leonard DeGollado, Bethesda, MD (US); Gene Ray Griffin JR., Crofton, MD (US)

Correspondence Address: RICHARD M. GOLDMAN, 371 ELAN VILLAGE LANE, SUITE 208, CA, 95134, US

(73) Assignee: International Business Machines Corporation

(21) Appl. No.: 10/449,247

(22) Filed: May 29, 2003

(51) Int. Cl. H04N 7/12

(52) U.S. Cl. 375/240.01; 375/240; 375/240.12

(57) ABSTRACT

A video encoder system and method for receiving uncompressed streaming video and outputting a continuous compressed video stream. The system a video encoder to compress the input video stream; and a formatter and indexer to receive the compressed video stream, apply indexing metadata and formatting metadata to the video stream, and output a formatted video stream that is capable of storage and access.

### FIELD OF THE INVENTION

The invention relates to real time compression of streaming media content with the compressed media content being immediately available for further processing and use.

### BACKGROUND

Current media production systems, for example, the IBM Media Production Suite, use a video server, for example, the Sony MAV-70 or the Grass Valley Profile as a high-resolution encoder or video server. The video server includes both an encoder subsystem that compresses the uncompressed input video and a storage subsystem, for example, disk storage, where the compressed file is written. The compressed files can be offloaded via FTP from the server, but, and this is a serious limitation, only after the files have been closed.

This inability to off-load compressed files in real-time, that is, to wait until they have been closed, is not normally a serious problem for video archiving. But it creates problems in the typical real-time production environment, for example, the typical news production environment, where immediate access to the compressed video is highly desirable. Thus, a need exists for a real-time streaming media encoder that provides real time access to compressed media, e.g., for editing and broadcasting. By a real time streaming media encoder we mean one that is capable of producing a continuous stream of compressed data and not limited by the requirement for defined start and stop points, yet capable of storage in a computer recognizable data file.

### OBJECTS OF THE INVENTION

It is a primary object of the invention to provide a real-time streaming media encoder that is capable of producing a continuous stream of compressed data.

It is a further object of the invention that the real time streaming encoder not be limited by the requirement for defined start and stop points, while being capable of producing compressed media that can be stored in a computer recognizable data file.

It is a further object of the invention to provide a real time streaming encoder that segments the stream into manageable file lengths and adds the appropriate headers and trailers to the data so that the compressed media data constitutes a legitimate file.

### SUMMARY OF THE INVENTION

The method and system of our invention accomplishes these objects of providing a real-time streaming media encoder that produces a continuous stream of compressed data, and is not limited by a need for defined start and stop points, and that segments the data stream into files with appropriate headers and trailers.

The real-time streaming encoder encodes a continuous stream of compressed data that has no defined start and stop point. Storing this data into a computer recognizable data file requires segmenting the stream into manageable file lengths and adding the appropriate headers and trailers to the data so that it constitutes a legitimate file. The format for this file structure is usually referred to as a wrapper.

As described herein, video from a streaming source, for example, a camera or a tape machine is compressed in real-time by an encoder and the compressed bit stream is written, also in real-time, into storage, for example, disk storage. File formatting is performed on the real-time compressed stream on-the-fly. The compressed video data can be accessed (read) by a video editor or browser immediately after being written, without having to wait for the file to be closed.

The system and method of our invention utilizes a video encoder system that is adapted to receive uncompressed streaming video and to output a continuous compressed video stream that can be accessed and edited immediately, that is, in real time. The encoder system includes a video encoder subsystem and a formatter (formatter and indexer) subsystem. The video encoder compresses the input video stream. The formatter and indexer receives this compressed video stream, applies indexing metadata and formatting metadata to the video stream, and outputs a formatted video stream that is capable of storage and immediate, real time, access.

The video encoder subsystem compresses the input video stream. This results in an MPEG compressed video stream, for example an MPEG-2 video stream. This MPEG video stream is made up of four primitives, a video stream, an audio stream, a data stream, and a time code stream. In the formatter and indexer the compressed stream is demultiplexed back into primitive streams, that is, into the primitive video, audio, data, and time code streams. A content packager then operates on these streams, and metadata and formatting are added, to thereby yield compressed media content that is immediately available for both storage and editing.

In a preferred embodiment the encoder system further includes a parallel file system to receive the formatted video stream from the formatter and indexer. An editor, for example, a non-linear editor, may directly access the parallel file system, that is, in real time. This non-linear editor reads the formatted video stream from the parallel file system immediately after the formatted video stream is written to the parallel file system.

As used herein MXF refers to a Material Exchange Format formatter and indexer substantially as described generally in the Pro-MPEG Forum paper “Working Together With MXF,” and Bruce Devlin, “MXF—The Material Exchange Format” in EBU Technical Review, July 2002.

### THE FIGURES

The appended figures illustrate various aspects of the method and system of our invention.

FIG. 1 illustrates the overall system, including the device controller, the high and low resolution encoders, feature extraction, the Material Exchange Format (MXF) formatter and indexer, an ingest application, a locator, HSM, storage, and editors, including both the non-linear editor and the search client proxy editor.

FIG. 2 is a detailed view of the MFX formatter and indexer of FIG. 1, showing the MPEG2 Transport Demultiplexor, the content packager, the MFX metadata, the MFX formatter, and the indexer, and the write to disk output.

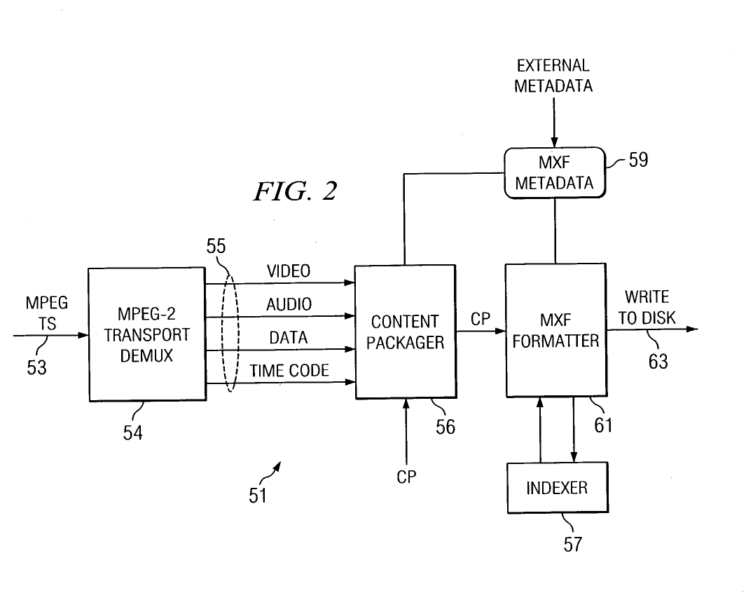

### DETAILED DESCRIPTION

As described herein video from the streaming source, for example, a camera or a tape machine, not shown, is compressed in real-time by an encoder subsystem, 11, 15, and the compressed bit stream is written, also in real-time, into disk storage, 21. File formatting is performed on the real-time compressed stream on-the-fly, by the MXF formatter and indexer, 51. With a parallel file system, 21, here illustrated as the IBM General Parallel File System (GPFS), the compressed video data can be accessed (read) by a video editor, 33, or browser, 35, immediately after being written, without having to wait for the file to be closed.

The method and system of our invention uses a real-time streaming encoder subsystem to capture video input. The encoder includes a high resolution encoder, 11, to capture a real time encoded stream, 13, and a low resolution (video compression) encoder, 15, to produce an MPEG transport stream, 17.

The high resolution encoder, 11, produces a real time encoded stream, 13, that is input to a high performance file system, 21, preferable a parallel file system. The low resolution encoder, 15, produces a data compressed video data stream, as an MPEG-2 transport stream, 17, that goes through a high performance file system server, 19, to the high performance file system.

The encoder subsystem, that is, elements 11, 15, and 19, produces a continuous stream of compressed data that has no defined start and stop point. Storing this data into a computer recognizable data file requires segmenting the stream into manageable file lengths and adding the appropriate headers and trailers to the data so that it constitutes a legitimate file. The format for this file structure is usually referred to as a wrapper.

The system and method of our invention utilizes a video encoder system that is adapted to receive uncompressed streaming video and to output a continuous compressed video stream, 31a, 31b, 31c, 31d, that can be accessed and edited immediately, that is, in real time. The encoder system includes a video encoder subsystem, 11, 15, and a formatter (formatter and indexer) subsystem, 51. The low resolution video encoder, 15, compresses the input video stream. The formatter and indexer, 51, receives this compressed video stream, applies indexing metadata, 57, and formatting metadata, 59, to the video stream, and outputs a formatted video stream, 63, that is capable of storage and immediate, real time, access.

The low resolution encoder (compressor), 15, in the video encoder subsystem compresses the input video stream. This results in an MPEG compressed video stream, 17, for example an MPEG-2 video stream. This MPEG-2 video stream, 17, is made up of four primitives, 55, a video stream, an audio stream, a data stream, and a time code stream. In the formatter and indexer, 51, the compressed stream is demultiplexed, 54, back into primitive streams, that is, into the primitive video, audio, data, and time code streams. A content packager, 56, then operates on these streams, and metadata, 59, and formatting, 57, are added, to thereby yield compressed media content, 63, that is immediately available for both storage and editing.

In a preferred embodiment of our invention the formatter and indexer is based on and utilized the SMPTE Material Exchange Format (MXF). By MXF we mean a file system that is characterized by a file header, a file body, and a file footer, where the file header includes a header partition pack and header metadata, and every item in the file is Key Length Value (KLV) coded. KLV coding means that every item in the file has a unique 16 byte key and a length. Defining the length of every field in the file, including the file body or essence container, facilitates MXF coding and packaging.

The header metadata of the MXF file is the area where metadata is added and the timing and synchronization parameters of the MXF file are defined.

In the MXF file, the synchronization and description of the file body or essence container is controlled by three packages, a material package, a file package, and a source package. The material package represents the output timeline of the MXF file. The actual essence or content is described by the file package, and the derivation of the essence or content is contained within the source package.

Each of the MXF packages, the material package, the file package, and the source package, has one or more tracks. These tracks represent each of the different elements of the essence or content, as a picture track for the video, a sound track for the audio, and a metadata track. The tracks hold sequences of source clips. These source clips define how to create the desired output file.

In a preferred embodiment the encoder system further includes a parallel file system, 21, to receive the formatted video stream from the formatter and indexer, 51. An editor, for example, a non-linear editor, 33, may directly access the parallel file system, 21, that is, in real time. This non-linear editor, 33, reads the formatted video stream, 63, from the parallel file system, 21, immediately after the formatted video stream, 63, is written to the parallel file system, 21.

In a preferred embodiment of our invention, the encoder, 11 and 15, accepts ITU-R 601 (SDI) video/audio and produces an encoded MPEG-2 stream, 17, at an average bit rate determined by the customer requirements. Typically this will be 4:2:2 50 Mbps I-frame only or 18 Mbps 15 GOP. (50 Mbps Dy can also be supported). This MPEG-2 stream may be transported in one of several possible formats:

1. DVB-ASI—MPEG-2 transport stream packets (188 byte) carried over a 270 Mbps serial SDI interface.

2. SDTI-CP—SMPTE 326M defined Content Packages containing compressed MPEG-2 or DV video/audio/data carried over a 270 Mbps or 360 Mbps serial interface.

3. ATM—MPEG-2 transport stream packets carried on ATM cells over an OC-3 (155 Mbps) line or higher.

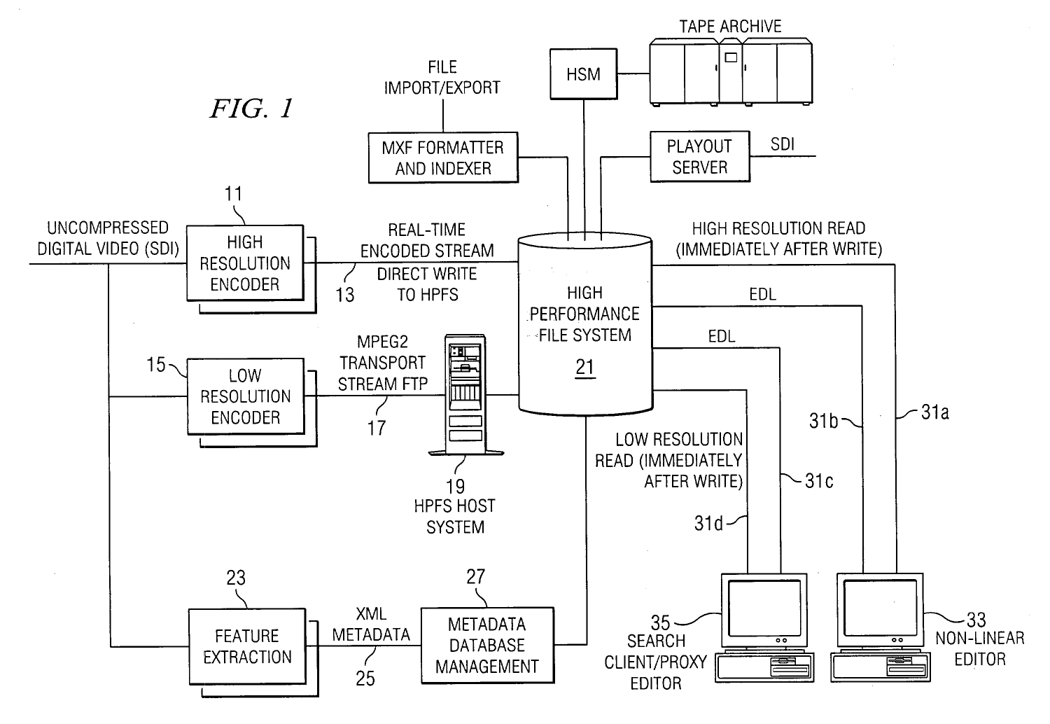

The physical interfaces illustrated in FIG. 1 allow DVB-ASI and SDTI-CP data to be carried over a coaxial serial interface at 270 Mbps or higher as defined in SMPTE Specification 259M. ATM cells can be carried over any appropriate physical medium such as optical OC-3.

The formatter and indexer, 51, takes the output of the encoder, adds a file header and, optionally, a trailer, and writes it directly onto the parallel file storage system, 21. Various formatting functions may be utilized and implemented in the formatter and indexer.

If the encoder is putting out a DVB-ASI or ATM stream, this stream is the form of 188 byte MPEG-2 transport stream packets. The arrival rate is variable, and may be a function of the encoded content and the settings of the encoder. The stream packets are either written directly to the disk, tape, or other storage media or preferable reformatted in Material Exchange Format (MXF). For MXF the transport stream is demultiplexed and separated into video, audio and data components (elementary streams). These elementary streams are packaged as content packages (CPs) and additional metadata is inserted to complete the file format requirements.

When the encoder puts out SDTI-CP, it is only necessary to add MXF headers and trailers and write the MXF formatted data to the storage system, 21, in MXF. For MXF files the formatter/indexer, 51, also creates and inserts the MPEG index file that relates frame count to byte count in the file.

While some current non-linear editors (NLEs)s can deal directly with MPEG-2 transport stream format, the method and system described herein also implement Advanced Authoring Format (AAF), which is a superset of MXF. An AAF NLE can accept content in MXF format and produce an AAF file that will contain the content by reference and the EDL required to render it. Such an editor can also mount the parallel file system content file through NFS to avoid actual movement of the data.

The method and system described herein uses a real-time streaming encoder to produce a continuous stream of compressed data that has no defined start and stop point with segmenting of the compressed media stream into manageable file lengths and adding the appropriate headers and trailers to the data so that it constitutes a legitimate file. The format for this file structure is usually referred to as a wrapper.

While the invention has been described with respect to certain preferred embodiments and exemplifications of the invention, it is not intended to limit the scope of the invention thereby, but solely by the claims appended hereto.

We claim:

1. A video encoder system adapted to receive an uncompressed video stream and output a continuous compressed video stream, said encoder system comprising:
a. a video encoder subsystem to compress the uncompressed input video stream; and
b. a formatter and indexer to receive the compressed video stream, apply indexing metadata and formatting metadata to the video stream, and output a formatted video stream that is capable of storage and access.

2. The video encoder system of claim 1 wherein the formatter and indexer subsystem outputs a formatted video stream that is capable of real time storage and access.

3. The video encoder system of claim 1 wherein the video encoder compresses the input video stream to produce an MPEG compressed video stream.

4. The video encoder system of claim 1 wherein the formatter and indexer demultiplexes the compressed video stream into primitive streams.

5. The video encoder system of claim 4 wherein the formatter and indexer demultiplexes the compressed video stream into primitive video, audio, data, and time code streams.

6. The video encoder system of claim 1 wherein the formatter and indexer adds headers and trailers to the video stream.

7. The video encoder system of claim 1 wherein the formatter and indexer segments the video stream.

8. The video encoder system of claim 1 further including a parallel file system to receive the formatted video stream from the formatter and indexer.

9. The video encoder system of claim 8 further including at least one non linear editor for reading formatted video streams from the parallel file system immediately after the formatted video stream is written to the parallel file system.

10. A method of processing video streams including receiving an uncompressed video stream and outputting a continuous compressed video stream, said method comprising:
a. compressing the uncompressed input video stream; and
b. applying indexing metadata and formatting metadata to the compressed video stream, and outputting a formatted video stream that is capable of storage and access.

11. The method of claim 10 wherein the compressed video stream comprises primitive video, audio, data, and time code stream, and the step of applying indexing metadata and formatting metadata to the compressed video stream includes demultiplexing the compressed video stream into the primitive streams.

12. The method of claim 10 further comprising outputting the formatted video stream for storage and access in a parallel file system.

13. The method of claim 10 further comprising adding headers and trailers to the video stream.

14. The method of claim 10 further comprising segmenting the video stream.
